(19) United States
(12) Patent Application Publication
(10) Pub. No.: US 2006/0077794 A1
(43) Pub. Date: Apr. 13, 2006

(54) Objective optical system for optical recording media and optical pickup device using the objective optical system

(75) Inventors: Toshiaki Katsuma, Tokyo (JP); Yu Kitahara, Saitama City (JP); Masao Mori, Saitama City (JP); Tetsuya Ori, Koshigaya City (JP)

Correspondence Address: ARNOLD INTERNATIONAL, P. O. BOX 129, GREAT FALLS, VA, 22066-0129, US

(73) Assignee: FUJINON CORPORATION

(21) Appl. No.: 11/231,834

(22) Filed: Sep. 22, 2005

(30) Foreign Application Priority Data
Sep. 30, 2004 (JP) 2004-289159

(51) Int. Cl. G11B 7/00

(52) U.S. Cl. 369/44.23; 369/112.23; 369/44.37

(57) ABSTRACT

An objective optical system for focusing light from a light source onto at least two different types of optical recording media having different substrate thicknesses in order to record or reproduce information on the optical recording media includes at least two lens groups arranged along an optical axis for focusing light of each one of two wavelengths that are the same or very nearly the same from the light source on a different one of the at least two different types of optical recording media, such as an AOD and a BD, having different substrate thicknesses. The separations of the two lens groups are different when light of each wavelength is used, and four different types of optical recording media with different substrate thicknesses may be used. An optical pickup device includes the objective optical system, the recording media, and a light source supplying the light of the two wavelengths.

### TECHNICAL FIELD OF THE INVENTION

The present invention relates to an objective optical system for optical recording media that, when recording or reproducing information, efficiently focuses light of different wavelengths onto an appropriate corresponding recording medium according to standardized characteristics such as the numerical aperture of the objective optical system used, the wavelength of the light selected, and the substrate thickness of the optical recording medium. The present invention also relates to an objective optical system for optical recording media that focuses light of two wavelengths that are the same, or very nearly the same, on a different one of two different types of optical recording media having different substrate thicknesses, and it also relates to an optical pickup device using such an objective optical system.

### BACKGROUND OF THE INVENTION

In response to the recent development of various optical recording media, optical pickup devices that can carry out recording and reproducing using two alternative types of optical recording media have been known. For example, devices that record or reproduce information with either a DVD (Digital Versatile Disk) or a CD (Compact Disk including CD-ROM, CD-R, CD-RW) have been practically used. Furthermore, the DVD, in order to improve the recording density, is designed to use visible light with a wavelength of approximately 658 nm. In contrast, because there are also optical recording media that do not have any sensitivity to light in the visible light region, near-infrared light with a wavelength of 784 nm is used for the CD. Further, in these two optical recording media, it is necessary to differentiate the numerical apertures (NA) due to the differences in the characteristics of the two optical recording media. However, the substrate thickness, that is, the geometric thickness of a protective layer formed with PC (polycarbonate), of each of the two different optical recording media is standardized to a different thickness. For example, the substrate thickness of the DVD is 0.6 mm and the substrate thickness of the CD is 1.2 mm.

In addition, a semiconductor laser with a short wavelength (for example, that emits a laser beam with a wavelength of 408 nm) using a GaN substrate has been put into practical use, and in response to the demand for increasing recording capacity, AODs (Advanced Optical Disks), also known as HD-DVDs, that provide approximately 20 GB of data storage on a single layer of a single side of an optical disk by using this short wavelength light is about to be put to practical use. Further, a Blue-ray Disc (hereafter, referred to as ‘BD’) where a light with a short wavelength is used as an irradiation light similar to the AOD is almost ready to be put into practical use.

In the standards for AODs, the numerical aperture and the substrate thickness are standardized to the same values as those of DVDs, specifically a numerical aperture (NA) of 0.65 and the substrate thickness of 0.6 mm. In contrast, in the standards for BDs (Blu-ray disk systems), the numerical aperture (NA) and the substrate thickness are standardized to completely different values from the values for DVDs and CDs. Specifically, for BDs, the standard numerical aperture (NA) is 0.85 and the standard substrate thickness is 0.1 mm.

Therefore, an optical pickup device where any of three optical recording media (namely, an AOD, DVD and CD, or a BD, DVD and CD) can be used, has also been progressing.

As mentioned above, with these optical recording media, because the standardized wavelengths and substrate thicknesses differ from one another depending upon the type of the optical recording medium being used, the spherical aberration generated by the substrates differs based on differences in thicknesses of the substrates (protective layers). Therefore, in these optical pickup devices, because it is necessary to optimize the spherical aberration relative to the light beams of various wavelengths in order to assure a proper focus onto the different recording media for recording or reproducing information, it is necessary to devise a lens configuration that has a different light convergence effect on each of the optical recording media for the objective lens for optical recording media mounted in these devices.

Applicants of the present invention have already suggested various objective lenses for optical recording media in the specifications of Japanese Laid-Open Patent Applications 2005-190620, 2005-158213, and 2005-093030. In the objective lenses for optical recording media of the Japanese applications listed above, light beams of different wavelengths are focused on the recording medium of each of the CD, the DVD, and the AOD (or the BD). This is achieved, for example, using an objective optical system for optical recording media that includes two lens components and diffractive optics with wavelength splitting properties combined in an objective lens in order to achieve optimization of spherical aberrations generated by differences in the thicknesses of the substrates (protective layers) of the optical recording media.

As mentioned above, since AODs and BDs are approaching practical use, there is a demand to be able to record and reproduce information using four types of optical recording media, that is, using AODs and BDs, in addition to CDs and DVDs, as the optical recording media with a single objective lens.

However, as mentioned above, light beams with the same, or very nearly the same, wavelength, for example, 408 nm or very nearly 408 nm, are used for both AODs and BDs, and according to the teachings of the Japanese applications listed above, where the light convergence effects are changed based on differences in wavelengths of the light beams being used, the use of the same, or very nearly the same wavelength, does not support using both a BD and an AOD with a single objective lens.

Therefore, it is necessary to adopt new concepts in order to realize an objective lens for an optical recording media that can be used for at least both an AOD and a BD.

### BRIEF SUMMARY OF THE INVENTION

The present invention relates to an objective optical system for optical recording media that can efficiently focus light beams of the same, or very nearly the same, wavelength on different recording media with different technical standards of the substrate thickness. The present invention further relates to an optical pickup device using this objective optical system.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1A-1D are schematic diagrams that depict cross-sectional views of the objective optical system of an embodiment of the present invention, with FIG. 1A showing the operation of the objective optical system when used with a first optical recording medium 9a, with FIG. 1B showing the operation of the objective optical system when used with a second optical recording medium 9b, with FIG. 1C showing the operation of the objective optical system when used with a third optical recording medium 9c, and with FIG. 1D showing the operation of the objective optical system when used with a fourth optical recording medium 9d; and

FIG. 2 is a schematic diagram of an optical pickup device using the objective optical system of FIGS. 1A-1D.

### DETAILED DESCRIPTION

The present invention relates to an objective optical system for optical recording media that can be used to focus each of four light beams of four wavelengths, λ1, λ2, λ3, and λ4 from a light source to a different desired position for each of first, second, third, and fourth optical recording media of substrate thicknesses, T1, T2, T3, and T4, respectively, for recording and reproducing information. As herein defined, unless otherwise indicated, the term “light source” refers to the source of the four different light beams of at least four wavelengths (but not necessarily four different wavelengths), whether the light beams originate from a single light emitting source or from separate light emitting sources, such as semiconductor lasers. Additionally, the term “light source” may also include various optical elements, including beamsplitters, mirrors, and converging lenses, which for one or more of the light beams of wavelengths λ1, λ2, λ3, and λ4 may operate as a collimator lens to provide a collimated light beam incident on the objective optical system.

The objective optical system includes, from the light source side: diffractive optics with at least one surface of the diffractive optics being a diffractive surface defined by a phase function Φ, as will be discussed in detail later; and an objective lens of positive refractive power with both surfaces being rotationally symmetric aspheric surfaces. The phase function Φ is chosen so that the objective optical system is able to focus each of the four light beams of four wavelengths, λ1, λ2, λ3, and λ4 at a different desired position for each of the first, second, third and fourth optical recording media of substrate thicknesses, T1, T2, T3, and T4, respectively.

The objective optical system is constructed so that collimated light of each wavelength, λ1, λ2, λ3, and λ4, diffracted by the diffractive optical element is efficiently focused onto the desired position of the corresponding optical recording media of substrate thickness, T1, T2, T3, and T4, respectively. In order for this to occur at all wavelengths, preferably the diffraction order of the diffracted light of at least one wavelength is different from the diffraction order of the diffracted light of at least one other wavelength.

Additionally, numerical apertures NA1, NA2, NA3, and NA4 of the objective optical system are associated with the wavelengths λ1, λ2, λ3, and λ4, respectively, and the substrate thickness of T1, T2, T3, and T4, respectively, of the four recording media.

In summary, throughout the following descriptions the following definitions apply:
NA1 is the numerical aperture of the objective optical system for light of the first wavelength λ1 that is focused on the optical recording medium of substrate thickness T1;
NA2 is the numerical aperture of the objective optical system for light of the second wavelength λ2 that is focused on the optical recording medium of substrate thickness T2;
NA3 is the numerical aperture of the objective optical system for light of the third wavelength λ3 that is focused on the optical recording medium of substrate thickness T3; and
NA4 is the numerical aperture of the objective optical system for light of the fourth wavelength λ4 that is focused on the optical recording medium of substrate thickness T4.

Additionally, in the objective optical system of the present invention, light beams of two wavelengths among the wavelengths λ1, λ2, λ3, and λ4 are the same or very nearly the same. The phrase “the same or very nearly the same” means that the wavelengths may be considered the same, that is, equal to one another, for purposes of design, construction, and operation of the objective optical system. Furthermore, as exemplary and in accordance with the current use of wavelengths of light beams in objective optical systems for optical recording media, the wavelengths that are the same are taken as shorter wavelengths than the other two of the four wavelengths so that the following conditions are satisfied:
λ1=λ4<λ2<λ3 Condition (1)
NA4>NA1≧NA2>NA3 Condition (2)
T4<T1≦T2<T3 Condition (3).

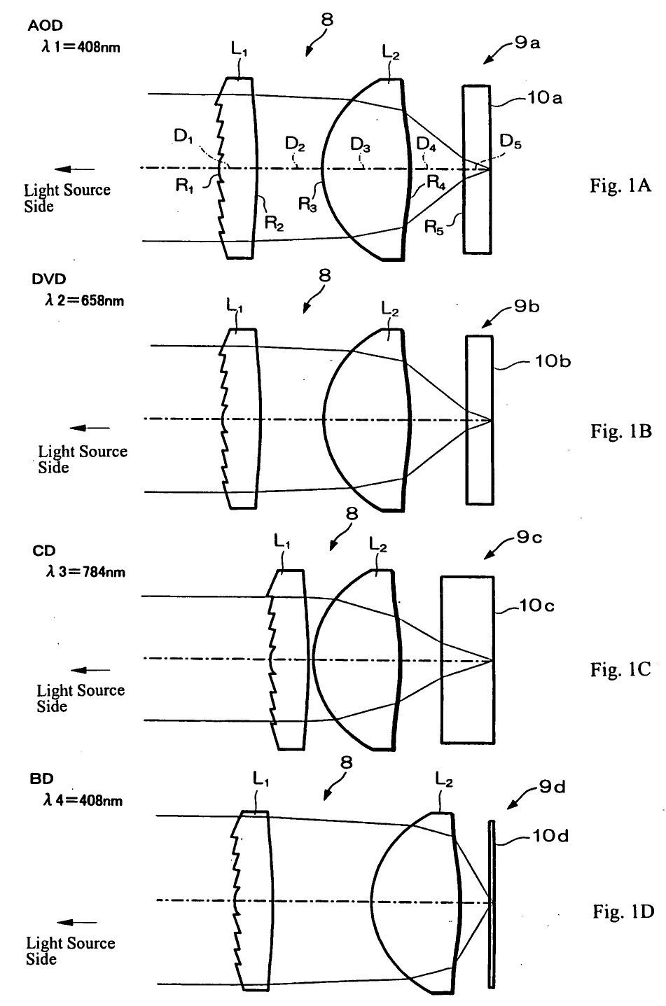

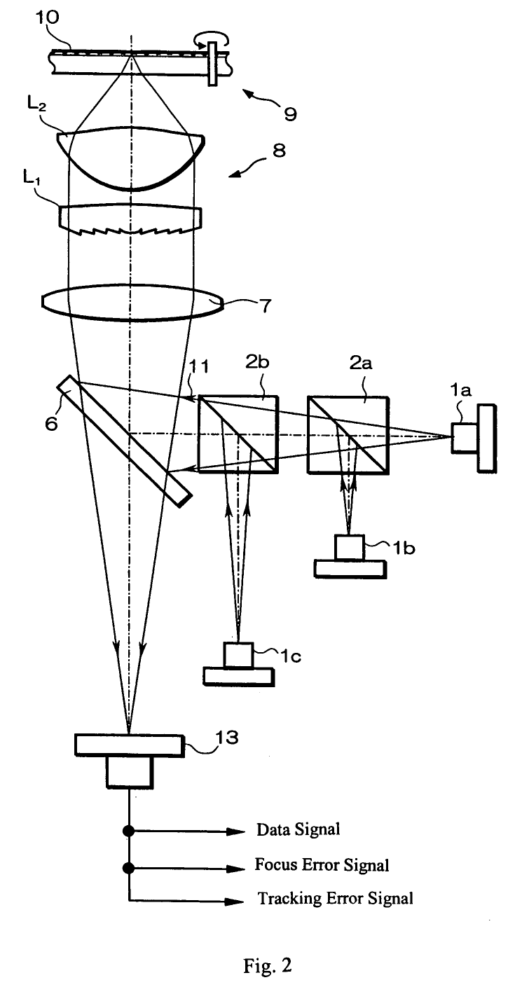

The invention will now be discussed in general terms with reference to FIGS. 1A-1D that show the geometry of the objective optical system of an embodiment of the present invention and FIG. 2 that shows an optical pickup device using the objective optical system of this embodiment. The figures show the elements of the objective optical system schematically. In order to prevent FIG. 2 from being too complicated, only one pair of light rays from each light beam are illustrated at every location of the objective optical system in FIG. 2, even where light of more than one wavelength is present, including at the prisms 2a and 2b. Additionally, in FIGS. 1A-1D and FIG. 2, a diffractive surface is shown as exaggerated in terms of an actual serrated shape in order to more clearly show the diffractive nature of the surface.

As shown in FIG. 2, a laser beam 11 that is emitted from one of the semiconductor lasers 1a, 1b, and 1c is reflected by a half mirror 6, is collimated by a collimator lens 7, and is focused by the objective optical system 8 onto a recording area 10 of an optical recording medium 9. Hereinafter, the term “collimated” means that any divergence or convergence of the light beam is so small that it can be neglected in computing the image-forming properties of the objective optical system 8 for the light beam. The laser beam 11 is converted to a convergent beam by the objective optical system 8 so that it is focused onto the recording region 10 of the optical recording medium 9.

More specifically, as shown in FIGS. 1A-1D, the arrangement includes an optical recording medium 9a that is an AOD with a substrate thickness T1 of 0.6 mm used with a light beam of wavelength λ1 that is equal to 408 nm and with a numerical aperture NA1 of 0.65 (FIG. 1A), an optical recording medium 9b that is a DVD with a substrate thickness T2 of 0.6 mm used with a light beam of wavelength λ2 that is equal to 658 nm and with a numerical aperture NA2 of 0.65 (FIG. 1B), an optical recording medium 9c that is a CD with a substrate thickness T3 of 1.2 mm used with a light beam of wavelength λ3 that is equal to 784 nm and with a numerical aperture NA3 of 0.50 (FIG. 1C), and an optical recording medium 9d that is a BD with a substrate thickness T4 of 0.1 mm used with a light beam of wavelength λ4 that is equal to 408 nm and with a numerical aperture NA4 of 0.85 (FIG. 1D).

The semiconductor laser 1a emits the visible laser beam having the wavelength of approximately 408 nm (λ1, λ4) for AODs and BDs. The semiconductor laser 1b emits the visible laser beam having the wavelength of approximately 658 nm (λ2) for DVDs. The semiconductor laser 1c emits the near-infrared laser beam having the wavelength of approximately 784 nm (λ3) for CDs such as CD-R (recordable optical recording media) (hereinafter the term CD generally represents CDs of all types).

The arrangement of FIG. 2 does not preclude semiconductor lasers 1a-1c providing simultaneous outputs. However, it is preferable that the lasers be used alternately depending on whether the optical recording media 9 of FIG. 2 is specifically, as shown in FIGS. 1A-1D, an AOD 9a, a DVD 9b, a CD 9c, or a BD 9d. As shown in FIG. 2, the laser beams output from the semiconductor lasers 1a, 1b irradiate the half mirror 6 by way of prisms 2a, 2b, and the laser beam output from the semiconductor laser 1c irradiates the half mirror 6 by way of the prism 2b.

The collimator lens 7 is schematically shown in FIG. 2 as a single lens element. However, it may be desirable to use a collimator lens made up of more than one lens element in order to better correct chromatic aberration of the collimator lens 7. In general, the constitution of the objective optical system is illustrated as simply as possible in terms of lens elements in FIGS. 1A-1D. Definitions of the terms “lens element”, “lens component”, “lens group”, “lens”, and “diffractive optics” that relate to this detailed description will now be given. The term “lens element” is herein defined as a single transparent mass of refractive material having two opposed refracting surfaces, which surfaces are positioned at least generally transversely of the optical axis of the collimator lens. The term “lens component” is herein defined as (a) a single lens element spaced so far from any adjacent lens element that the spacing cannot be neglected in computing the optical image forming properties of the lens elements or (b) two or more lens elements that have their adjacent lens surfaces either in full overall contact or overall so close together that the spacings between adjacent lens surfaces of the different lens elements are so small that the spacings can be neglected in computing the optical image forming properties of the two or more lens elements. Thus, some lens elements may also be lens components. Therefore, the terms “lens element” and “lens component” should not be taken as mutually exclusive terms. In fact, the terms may frequently be used to describe a single lens element in accordance with part (a) above of the definition of a “lens component.” Alternatively, a lens component may frequently be made by cementing together two lens elements. The term “lens group” is herein defined as an assembly of one or more lens components in optical series and with no intervening lens components along an optical axis that is movable as a single unit relative to another lens component or other lens components in order to adjust the focusing properties of the objective optical system and focus light appropriately on different recording media.

Additionally, a refractive structure identified simply as a “lens” that is not otherwise limited to being a single lens element or a single lens component may be made of a plurality of lens elements or lens components, the latter of which may in turn be made of a plurality of lens elements. Thus, the collimator lens may be made up of a plurality of lens components rather than being a single lens element as shown in FIG. 2.

Furthermore, a diffractive surface may be formed on a surface of a lens element. In this case, whether the lens element with the diffractive surface has an air space on each side to thereby define a lens component or contacts the surface of another lens element with the same curvature to form part or the whole of a lens component made of a plurality of lens elements, and whether or not a lens group includes only a single lens element, only a single lens component, or a plurality of lens components, the lens group forms “diffractive optics” as long as at least one surface of a lens element of the lens group includes a diffractive surface. Thus, the term “diffractive optics” may refer to a single lens element that includes at least one diffractive surface, to a single lens component that includes one or a plurality of lens elements and that includes at least one diffractive surface, and/or to a lens group that includes one or a plurality of lens components and that includes at least one diffractive surface.

In the optical pickup device of the present invention, each of the optical recording media 9, as shown in FIG. 2, whether an AOD 9a, a DVD 9b, a CD 9c, or a BD 9d, as shown in FIGS. 1A-1D, respectively, must be arranged at a predetermined position along the optical axis, for example, on a turntable, so that the recording region 10 of FIG. 2 (one of recording regions 10a, 10b, 10c, and 10d of an AOD 9a, a DVD 9b, a CD 9c, and a BD 9d of FIGS. 1A-1D, respectively) is positioned at the focus of the light beam of the corresponding wavelength λ1, λ2, λ3, and λ4 for recording regions 10a, 10b, 10c, and 10d, respectively) in order to properly record signals and reproduce recorded signals. The light beams enter the objective optical system 8 as collimated light beams so that the objective optical system 8 operates with an infinite conjugate on the light source side. Due to the diffractive effects and the refractive effects of diffractive optics L₁ and the refractive effects of an objective lens L₂, each of which in FIGS. 1A-1D and FIG. 2 is shown as a lens element that is a lens component, each light beam is efficiently focused on the appropriate corresponding recording medium, AOD 9a as shown in FIG. 1A, DVD 9b as shown in FIG. 1B, CD 9c as shown in FIG. 1C, or BD 9d as shown in FIG. 1D.

In the recording region 10, pits carrying signal information are arranged in tracks. The reflected light of a laser beam 11 from the recording region 10 is made incident onto the half mirror 6 by way of the objective optical system 8 and the collimator lens 7 while carrying the signal information, and the reflected light is transmitted through the half mirror 6. The transmitted light is then incident on a four-part photodiode 13. The respective quantities of light received at each of the four parts of the four-part photodiode 13 are converted to electrical signals that are operated on by calculating circuits (not shown in the drawings) in order to obtain data signals and respective error signals for focusing and tracking.

Because the half mirror 6 is inserted into the optical path of the return light from the optical recording media 9 at a forty-five degree angle to the optical axis, the half mirror 6 introduces astigmatism into the light beam, as a cylindrical lens may introduce astigmatism, whereby the amount of focusing error may be determined according to the form of the beam spot of the return light on the four-part photodiode 13. Also, a grating may be inserted between the semiconductor lasers 1a-1c and the half mirror 6 so that tracking errors can be detected using three beams.

As shown in FIGS. 1A-1D and FIG. 2, the objective optical system 8 of the present invention includes, in order from the light source side, diffractive optics L₁ that includes one diffractive surface, and objective lens L₂. The diffractive surface is defined by the phase function Φ. When recording or reproducing information using multiple optical recording media where the wavelengths of the light to be used are the same or very nearly the same, at least one of the diffractive optics L₁ and the objective lens L₂ is movable so as to change the separation between the diffractive optics L₁ and the objective lens L₂ according to the type of the optical recording media being used. For example, as shown in FIGS. 1A-1D, the configuration is such that the separations between the diffractive optical element L₁ (that forms the diffractive optics L₁) and the objective lens L₂ are different from each other between the case of selecting the AOD 9a and the case of selecting the BD 9d. In particular, in the objective optical system 8 shown in FIGS. 1A-1D, a comparison of FIG. 1A and FIG. 1D shows that when recording or reproducing information using the BD 9d (see FIG. 1D) the separation D₂ between the diffractive optics L₁ and the objective lens L₂ is larger than when recording or reproducing information using the AOD 9a (see FIG. 1A). Each of the diffractive optics L₁ and the objective lens L₂ forms a lens group, each of which is a single lens component and a single lens element as shown in FIGS. 1A-1D.

In the present invention, regarding two types of optical recording media with different substrate thicknesses, when configured so that the spherical aberration becomes small upon recording or reproducing using one optical recording medium, the spherical aberration becomes excessive upon recording or reproducing using the other recording medium. The adjustment of the separation between the diffractive optics L₁ and the objective lens L₂ prevents the generation of excessive spherical aberration when recording or reproducing information using the AOD 9a where the substrate thickness of the recording medium is standardized to be 0.6 mm and when recording or reproducing information using the BD 9d where the substrate thickness of the recording medium is standardized to be 0.1 mm. In particular, the wavelength of the light to be used for the AOD 9a and the BD 9d is designed to be the same, and it is difficult to adopt a conventional method where the change of the refractive effect and/or the diffractive effect in the objective optical system for optical recording media according to the wavelength of this light to be used results in appropriately changing the position of the focus of the light beam. Therefore, the technique according to the present embodiment, which does not depend upon the use of different wavelengths of light, is extremely effective.

However, the techniques according to the present invention can be applied not only to multiple optical recording media where the wavelengths of the light beams being used are the same, but they can also be applied to multiple optical recording media where the wavelengths of the light beams being used differ from one other.

For example, in the objective optical system 8 shown in FIGS. 1A-1D, compared to when recording or reproducing information using the AOD 9a (see FIG. 1A), when recording or reproducing information using the DVD 9b where the substrate thickness of the optical recording medium is the same (see FIG. 1B), specifically 0.6 mm, the separation D₂ on the optical axis between the diffractive optics L₁ and the objective lens L₂ is the same or very nearly the same. However, when recording or reproducing information using the CD 9c where the substrate thickness of the recording medium is standardized to be thicker, at 1.2 mm, the separation between the diffractive optics L₁ and the objective lens L₂ is made smaller.

It is generally considered that only satisfying the requirement of using the diffractive optics L₁ enables focusing the light beams at the desired positions with favorable correction of aberrations on different optical recording media when collimated light beams of two different wavelengths are used. However, it is difficult to focus collimated light beams of the same wavelength at the appropriate positions on different optical recording media with favorable correction of aberrations because of the spherical aberration generated. In the present invention, the design is such that the separation between the diffractive optics L₁ and the objective lens L₂ changes so as to obtain appropriate focus positions and to achieve favorable correction of aberrations, including spherical aberration, for different optical recording media even when light beams of the same or very nearly the same wavelengths are used.

As described above, according to the objective optical system 8, even in the case of recording or reproducing information using any one of the optical recording media, AOD 9a, DVD 9b, CD 9c or BD 9d, the light beam being used can enter the objective optical system 8 as a collimated light beam, which enables the degree of freedom for the arrangement of the optical system to be increased and a compact device to be realized. At the same time, tracking stability can be improved.

Furthermore, well known lens driving mechanisms can be used to provide the relative movement between the diffractive optics L₁ and the objective lens L₂ in order to vary their separation according to the optical recording medium being used.

A two-group construction (i.e., using the diffractive optics L₁ and the objective lens L₂) in the objective optical system 8 in which the separation of the two lens groups L₁ and L₂ may be changed enables favorable correction of spherical aberration generated due to differences in the substrate thickness caused by normal manufacturing variations for optical recording media having a single standardized thickness, as well as favorable correction of spherical aberration in other circumstances, such as where a multi-layer disc is used.

Furthermore, in the objective optical system 8, the separation between the diffractive optics L₁ and the objective lens L₂ may differ, as in the case of selecting one optical recording medium among the optical recording media 9 versus the case of selecting at least one other optical recording medium among the optical recording media 9. The construction can also be such that the separation on the optical axis between the diffractive optics L₁ and the objective lens L₂ is the same in the case of selecting two optical recording media of the optical recording media 9, and the separation on the optical axis between the diffractive optics L₁ and the objective lens L₂ is different in the case of selecting a remaining optical recording medium of the optical recording media 9. Making the separation the same in the case of selecting two different optical recording media reduces the complications of providing mechanical control of the movements of the diffractive optics L₁ and/or the objective lens L₂ and generally simplifies the device construction.

Additionally, in the objective optical system 8, when the separation between the diffractive optics L₁ and the objective lens L₂ differs between the case of selecting one of the optical recording media 9 and the case of selecting at least one remaining optical recording media 9, the construction can be such that all the separations are different from each other in the case of selecting any of the four types of optical recording media 9. This further enhances the degree of freedom in the design of the objective optical system 8.

Additionally, the diffractive surface of the diffractive optics L₁ preferably is designed so that the diffractive surface diffracts light of maximum intensity for the first wavelength λ1 and for the fourth wavelength λ4 at a diffraction order that is different from the diffraction order of maximum intensity for the second wavelength λ2 and that is different from the diffraction order of maximum intensity for the third wavelength λ3. The four light beams can be focused to appropriate desired diffraction efficiency by setting the diffraction orders of maximum intensity diffracted light as described above.

Even more preferably, the diffractive surface is designed so that it diffracts light of the first wavelength λ1 and the fourth wavelength λ4 with maximum intensity in a second-order diffracted beam, diffracts light of the second wavelength λ2 with maximum intensity in a first-order diffracted beam, and diffracts light of the third wavelength λ3 with maximum intensity in a first-order diffracted beam. By selecting the diffraction orders in this manner, the diffraction grooves of the diffractive surface can be made shallow, and all four light beams can be converged with high diffraction efficiency without applying an excessive burden on metal mold processing and/or the molding of the refractive lens surfaces.

For example, in an objective optical system 8 for optical recording media described more specifically later, the diffractive surface is designed so as to maximize the quantity of second-order diffracted light for a light beam of wavelength 408 nm (λ1, λ4) corresponding to AOD 9a and BD 9d, to maximize the quantity of first-order diffracted light for a light beam of wavelength 658 nm (λ2) corresponding to DVD 9b, and to maximize the quantity of first-order diffracted light for a light beam of wavelength 784 nm (λ3) corresponding to CD 9c.

Moreover, it is preferable that the diffractive surface of the objective optical system 8 of the present invention be formed as a diffractive structure on a ‘virtual plane’, herein defined as meaning that the surface where the diffractive structure is formed would be planar but for the diffractive structures of the diffractive surface, and that the virtual plane be perpendicular to the optical axis. Preferably, the cross-sectional configuration of the diffractive surface is serrated so as to define a so-called kinoform. FIGS. 1A-1D and FIG. 2 exaggerate the actual size of the serrations of the diffractive surfaces.

The diffractive surface adds a difference in optical path length equal to m·λ·Φ/(2π) to the diffracted light, where λ is the wavelength, Φ is the phase function of the diffractive surface, and m is the order of the diffracted light that is focused on a recording medium 9. The phase function Φ is given by the following equation:
Φ=ΣWᵢ·Y²ⁱ Equation (A)
where
Y is the distance in mm from the optical axis; and
Wᵢ is a phase function coefficient, and the summation extends over i.

The specific heights of the serrated steps of the diffractive surface of the diffractive optical element that forms diffractive optics L₁ are based on ratios of diffracted light of each order for the light beams of wavelengths λ1, λ2, λ3, and λ4. Additionally, the outer diameter of the diffractive surface can be determined by taking into consideration the numerical aperture (NA) of the objective optical system 8 and the beam diameter of the incident laser beam of each of the used wavelengths.

It is preferable that at least one surface of the objective optical system 8 of the present invention, including the objective lens L₂, be an aspheric surface. It is also preferable that the aspheric surfaces of the objective optical system 8 of the present invention be rotationally symmetric aspheric surfaces defined using the following aspherical equation in order to improve aberration correction for all of the recording media 9a, 9b, 9c, and 9d and in order to assure proper focusing during both recording and reproducing operations:
Z=[(C·Y²)/{1+(1−K·C²·Y²)^{1/2}}]+ΣAᵢ·Y²ⁱ Equation (B)
where
Z is the length (in mm) of a line drawn from a point on the aspheric lens surface at a distance Y from the optical axis to the tangential plane of the aspheric surface vertex,
C is the curvature (=1/the radius of curvature, R in mm) of the aspheric lens surface on the optical axis,
Y is the distance (in mm) from the optical axis,
K is the eccentricity, and
Aᵢ is an aspheric coefficient, and the summation extends over i.

It is preferable that the diffractive surface or diffractive surfaces formed on the diffractive optical element L₁ and the rotationally symmetric aspheric surface or surfaces formed on the diffractive optical element L₁ and/or the objective lens L₂ are determined so as to focus each of the four beams of light with the four wavelengths, λ1, λ2, λ3, and λ4, on a corresponding recording region 10, as shown in FIG. 2 (10a, 10b, 10c, 10d as shown in FIGS. 1A-1D, respectively) with excellent correction of aberrations.

Additionally, in the objective optical system 8 of the present invention, the diffractive optical element L₁ and the objective lens L₂ may either one or both be made of plastic. Making these optical elements of plastic is advantageous in reducing manufacturing costs and making manufacturing easier, and in making the system lighter, which may assist in high speed recording and replaying. In particular, using a mold makes manufacture of the diffractive optical element much easier than many other processes of manufacturing.

Alternatively, one or both of the diffractive optical element L₁ and the objective lens L₂ may be made of glass. Glass is advantageous for several reasons: it generally has optical properties that vary less with changing temperature and humidity than for plastic; and appropriate glass types are readily available for which the light transmittance decreases less than for plastic, even at relatively short wavelengths.

An embodiment of the objective optical system 8 of the present invention will now be set forth in detail.

FIGS. 1A-1D are schematic diagrams that depict cross-sectional views of the objective optical system of this embodiment of the present invention, with FIG. 1A showing the operation of the objective optical system when used with a first optical recording medium 9a, with FIG. 1B showing the operation of the objective optical system when used with a second optical recording medium 9b, with FIG. 1C showing the operation of the objective optical system when used with a third optical recording medium 9c, and with FIG. 1D showing the operation of the objective optical system when used with a fourth optical recording medium 9d. As shown in FIGS. 1A-1D, the objective optical system of the present invention includes, in order from the light source side, a diffractive optical element L₁ having positive refractive power and with the surface on the light source side being a diffractive surface formed as a diffractive structure on a virtual plane that is perpendicular to the optical axis and the surface on the recording medium side being a rotationally symmetric aspheric convex surface, and an objective lens L₂ that is a biconvex lens element, which has positive refractive power, with a rotationally symmetric aspheric surface on each side. The diffractive surface being formed as a diffractive structure on a virtual plane means that the surface where the diffractive structure is formed is planar but for the diffractive structures of the diffractive surface, and the virtual plane is perpendicular to the optical axis. The diffractive surface is defined by the phase function Φ defined by Equation (A) above and the rotationally symmetric aspheric surfaces are defined by Equation (B) above. The diffractive surface is formed with a cross-sectional configuration of concentric serrations that define a grating.

As indicated in FIGS. 1A-1D, the objective optical system 8 favorably focuses light of each wavelength, λ1, and λ4 of 408 nm, λ2 of 658 nm, and λ3 of 784 nm, onto a respective recording region 10a, 10d, 10b, and 10c of respective recording media 9a, 9d, 9b, and 9c which are an AOD, a BD, a DVD, and a CD, respectively. Additionally, as shown in FIGS. 1A-1D, the objective optical system operates with an infinite conjugate on the light source side with the substantially collimated light beams of all four wavelengths being incident on the objective optical system 8. Furthermore, in FIGS. 1B-1D, for purposes of simplifying the drawings, the radii of curvature R and separations D are not labeled. As shown in FIGS. 1A-1D, each of the light beams is used separately according to the optical recording media 9 being used.

Furthermore preferably the following condition is satisfied:
d3<d1=d2<d4 Condition (4)
where
d1 is the separation on the optical axis between the diffractive optical element L₁ and the objective lens L₂ when recording or reproducing information using the AOD 9a;
d2 is the separation on the optical axis between the diffractive optical element L₁ and the objective lens L₂ when recording or reproducing information using the DVD 9b;
d3 is the separation on the optical axis between the diffractive optical element L₁ and the objective lens L₂ when recording or reproducing information using the CD 9c; and
d4 is the separation on the optical axis between the diffractive optical element L₁ and the objective lens L₂ when recording or reproducing information using the BD 9d.

The objective optical system 8 is an objective optical system for optical recording media wherein light to be used is focused onto a desired position of each of the four types of optical recording media so as to satisfy Conditions (1)-(3) above, and the separation along the optical axis between the diffractive optics L₁ and the objective lens L₂ is 1.5 mm (d1) when recording or reproducing information using the AOD 9a, the separation along the optical axis between the diffractive optics L₁ and the objective lens L₂ is 1.5 mm (d2) when recording or reproducing information using the DVD 9b, the separation along the optical axis between the diffractive optics L₁ and the objective lens L₂ is 0.1 mm (d3) when recording or reproducing information using the CD 9c, and the separation along the optical axis between the diffractive optics L₁ and the objective lens L₂ is 2.2 mm (d4) when recording or reproducing information using the BD 9d.

The objective optical system for optical recording media of the present invention being thus described, it will be obvious that it may be varied in many ways. Furthermore, the optical pickup device of the present invention may also be varied in many ways.

For example, the objective optical system for optical recording media of the present invention is used with at least two types of optical recording media where it is configured so that recording or reproducing information is performed by light beams with the same or nearly the same wavelength. At the same time, their substrate thicknesses are different from each other, and even though the number of optical recording media is four or more, the present invention can be used by adjusting the separation between the lens groups so as to be appropriately changed according to the type of optical recording media being used. Therefore, in the examples above, it is possible that the objective optical system for optical recording media may be used for optical recording media having different substrate thicknesses, in addition to the AOD and the BD of the above examples.

Additionally, by using the objective optical system for optical recording media wherein the wavelengths of the light to be used are different from each other, the number of different types of optical recording media is nearly unlimited.

Furthermore, in the above examples, the light beams all enter as collimated light beams. However, objective optical systems of the present invention may be designed so that at least some of the light beams are incident as divergent light or as convergent light.

Additionally, in the above examples, only two lens groups are used. However, three or more lens groups may be used, and in that case, the objective optical system can be designed to change the multiple separations between various lens group according to the type of optical recording medium being used.

Furthermore, in the above examples, the diffractive surface is in the light source side lens group. However, the diffractive surface may be in the other lens group if only two lens groups are used, or in another of a plurality of other lens groups if more than two lens groups are used. Additionally, diffractive surfaces may be provided in more than one lens group, or in all the lens groups, regardless of the number of lens groups used.

Furthermore, the diffractive surface can be formed on a convex or a concave surface that has refractive power, and this surface can be an aspheric surface. Also, within the diffractive optics, the surface on the light source side may be a rotationally symmetric aspheric surface and the surface on the optical recording medium side may be a diffractive surface. Additionally, in the diffractive optics of the examples above, the rotationally symmetric aspheric surface is used for the surface that is not a diffractive surface. However, instead of this configuration, a flat surface, a spherical surface or a non-rotationally symmetric aspheric surface may be used. For example, it is possible that the diffractive surface is formed on a surface that has a refractive power, and a flat surface forms the other surface. Furthermore, both surfaces of the diffractive optics may be diffractive surfaces.

The diffractive surface of the objective optical system should be constructed so as to output a considerable quantity of diffracted light of the desired orders of diffracted light for the appropriate wavelengths, with 100% diffracted light of each appropriate order being the ideal. Additionally, the structure of the diffractive optical element is not limited to the serrated one, but, for example, a stair stepped structure may also be used.

In addition, the objective optical system may be configured so that none of the lens groups includes a diffractive surface.

Furthermore, the objective optical system is formed of two members, diffractive optics and an objective lens, either of which may be inclined relative to the optical axis in order to compensate, for example, for coma aberration due to inclination of an optical recording medium.

Furthermore, for the objective lens of the objective optical system, the configuration is not limited to the one wherein both the surface on the light source side and the surface on the optical recording medium side are rotationally symmetric aspheric surfaces. For example, a flat surface, a spherical surface, or a non-rotationally symmetric aspheric surface may be appropriately used.

Further, in the future, as the optical recording media, a medium other than the above-mentioned ones (for example, a medium where the wavelength of a light to be used is much shorter) may be developed, and even in such a case, it is clear that the present invention can be applied. In this case, as a lens material, it is preferable to use a material that has an excellent transmissivity for the wavelength of light to be used. For example, it is possible to use fluorlite or quartz as a lens material of the objective optical system for optical recording medium in the present invention.

Additionally, although in the optical pickup device described above three light sources that output light beams having wavelengths that differ from each other are used, a single light source that outputs two light beams having wavelengths different from each other can be used as a light source. For example, light of different wavelengths may be emitted from adjacent output ports. In such a case, instead of using prisms 2a and 2b as shown in FIG. 2, a single prism may be used in order to combine the light beams. In addition, one light source that can transmit lights with three different wavelengths from adjacent output ports can be used. In this case, for example, the prisms 2a and 2b shown in FIG. 2 become unnecessary.

Furthermore, in the optical pickup device, an aperture and/or aperture control device that has a wavelength selectivity may be arranged at the light source side of the objective optical system, or the aperture or aperture control device may be incorporated in the diffractive optics or in the objective lens.

In addition, the light source(s) that transmits each light beam to be used for the AOD 9a and the BD 9d can be separate. In this case, the wavelengths of the light to be separately transmitted can have very nearly the same wavelengths. However, the wavelengths will not be strictly identical where separate light sources are used.

Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An objective optical system for focusing light from a light source onto at least two different types of optical recording media having different substrate thicknesses in order to record or reproduce information on the optical recording media, the objective optical system comprising:
at least two lens groups arranged along an optical axis for focusing light of one of two wavelengths from the light source onto a different one of the at least two different types of optical recording media having different substrate thicknesses; wherein
said two wavelengths are the same or very nearly the same;
the objective optical system is configured so that light of one wavelength of said two wavelengths is focused onto one of the at least two different types of optical recording media having different substrate thicknesses when said two lens groups are separated by a first distance along the optical axis between said two lens groups;
the objective optical system is configured so that light of the other wavelength of said two wavelengths is focused onto another of the at least two different types of optical recording media having different substrate thicknesses when said two lens groups are separated by a second distance along the optical axis between said two lens groups; and
said first distance and said second distance are different from one another.

2. An objective optical system for focusing light from a light source onto at least four different types of optical recording media having different substrate thicknesses in order to record or reproduce information on the optical recording media, the objective optical system comprising:
at least two lens groups arranged along an optical axis for focusing light of one of two wavelengths from the light source onto a different one of the at least four different types of optical recording media having different substrate thicknesses; wherein
said two wavelengths are the same or very nearly the same;
the objective optical system is configured so that light of one wavelength of said two wavelengths is focused onto one of the at least four different types of optical recording media having different substrate thicknesses when said two lens groups are separated by a first distance along the optical axis;
the objective optical system is configured so that light of the other wavelength of said two wavelengths is focused onto another of the at least four different types of optical recording media having different substrate thicknesses when said two lens groups are separated by a second distance along the optical axis; and
said first distance and said second distance are different from one another.

3. The objective optical system according to claim 1, wherein:
said one of the at least two different types of optical recording media is an AOD; and
said another of the at least two different types of optical recording media is a BD.

4. The objective optical system according to claim 2, wherein:
said one of the at least four different types of optical recording media is an AOD; and
said another of the at least four different types of optical recording media is a BD.

5. The objective optical system of claim 1, wherein:
the objective optical system consists of two lens groups; and
at least one of said two lens groups includes a diffractive surface.

6. The objective optical system of claim 2, wherein:
the objective optical system consists of two lens groups; and
at least one of said two lens groups includes a diffractive surface.

7. The objective optical system of claim 3, wherein:
the objective optical system consists of two lens groups; and
at least one of said two lens groups includes a diffractive surface.

8. The objective optical system of claim 4, wherein:
the objective optical system consists of two lens groups; and
at least one of said two lens groups includes a diffractive surface.

9. An optical pickup device that includes the objective optical system according to claim 1.

10. An optical pickup device that includes the objective optical system according to claim 2.

11. An optical pickup device that includes the objective optical system according to claim 3.

12. An optical pickup device that includes the objective optical system according to claim 4.

13. An optical pickup device that includes the objective optical system according to claim 5.

14. An optical pickup device that includes the objective optical system according to claim 6.

15. An optical pickup device that includes the objective optical system according to claim 7.

16. An optical pickup device that includes the objective optical system according to claim 8.
